(19) United States
(12) Patent Application Publication
(10) Pub. No.: US 2026/0321049 A1
(43) Pub. Date: Oct. 15, 2026

(54) INFORMATION PROCESSING METHOD AND INFORMATION PROCESSING DEVICE

(71) Applicant: LegalOn Technologies, Inc., Tokyo (JP)

(72) Inventors: Shinya KATSUMATA, Tokyo (JP); Shogo FUJITA, Tokyo (JP); Keisuke GOTO, Tokyo (JP)

(21) Appl. No.: 19/691,576

(22) Filed: May 29, 2026

Related U.S. Application Data
(63) Continuation of application No. PCT/JP2024/041581, filed on Nov. 25, 2024.

(30) Foreign Application Priority Data
Nov. 30, 2023 (JP) 2023-202929

(51) Int. Cl. G06V 30/414; G06Q 50/18

(52) U.S. Cl. CPC G06V 30/414; G06Q 50/18

(57) ABSTRACT

An information processing method according to an embodiment includes: inputting text data related to a legal matter into a trained model, and outputting a matter outline that is generated by the trained model on the basis of the text data and is related to at least a past background of the legal matter and an item regarding examination of a legal document related to the legal matter.

### CROSS-REFERENCE TO RELATED APPLICATION

This application is a continuation of International Application No. PCT/JP2024/041581, filed on Nov. 25, 2024, which designates the United States, and which claims priority to Japanese Patent Application No. 2023-202929, filed on Nov. 30, 2023. The entire contents of each of the above-identified applications are incorporated herein by reference.

### BACKGROUND

Embodiments of the present disclosure relate to an information processing method and an information processing device.

Conventionally, for the purpose of effectively using information regarding legal affairs, there has been proposed a business information management system including: a contract consultation database that records contract consultation request information for requesting consultation for entering into a contract and contract request detailed information indicating details of a request for entering into a contract; a contract management database that records concluded contract information indicating an item related to a concluded contract; and an information management server that, when an instruction indicating that a contract is concluded is input by a terminal device, creates concluded contract information on the basis of the contract consultation request information and the contract request detailed information recorded in the contract consultation database, records the concluded contract information in the contract management database, and causes the terminal device to output the concluded contract information in response to an instruction from the terminal device (see Japanese Patent Application Laid-Open No. 2001-216407). However, there is room for improvement in operational efficiency in the use of information regarding legal affairs.

### SUMMARY

An information processing method according to an embodiment includes: inputting text data related to a legal matter into a trained model, and outputting a matter outline that is generated by the trained model on the basis of the text data and is related to at least a past background of the legal matter and an item regarding examination of a legal document related to the legal matter.

### BRIEF DESCRIPTION OF DRAWINGS

FIG. 1 is a schematic diagram for explaining an outline of an information processing system according to a first embodiment.

FIG. 2 is a block diagram illustrating an example of a hardware configuration of an information processing device according to the first embodiment.

FIG. 3 is a block diagram illustrating an example of a hardware configuration of a terminal device according to the first embodiment.

FIG. 4 is a diagram illustrating an example of functional blocks of the information processing device according to the first embodiment.

FIG. 5 is an example of a prompt for “summary” generation according to the first embodiment.

FIG. 6 is an example of a “summary” generated by the prompt of FIG. 5.

FIG. 7 is another example of a “summary” generated by the prompt of FIG. 5.

FIG. 8 is an example of a prompt for “topic” generation according to the first embodiment.

FIG. 9 is an example of a “topic” generated by the prompt of FIG. 8.

FIG. 10 is another example of a “topic” generated by the prompt of FIG. 8.

FIG. 11 is a diagram illustrating an example of a matter display screen according to the first embodiment.

FIG. 12 is a diagram illustrating an example of a matter outline edit screen according to the first embodiment.

FIG. 13 is a diagram illustrating an example of a display mode of a matter outline of a legal matter according to the first embodiment.

FIG. 14 is a diagram illustrating an example of functional blocks of the terminal device according to the first embodiment.

FIG. 15 is a flowchart illustrating an example of a flow of matter outline generation processing for a legal matter according to the first embodiment.

FIG. 16 is a flowchart illustrating an example of a flow of matter outline automatic generation processing for a legal matter according to a second embodiment.

FIG. 17 is a flowchart illustrating an example of a flow of matter outline modification processing for a legal matter according to the second embodiment.

FIG. 18 is a flowchart illustrating an example of a flow of matter outline automatic update processing for a legal matter according to the second embodiment.

### DESCRIPTION

### First Embodiment

Hereinafter, embodiments will be described in detail with reference to the drawings. Note that, in the following description, components having substantially the same functions and configurations are denoted by the same reference signs, and description will be made if necessary. In addition, the embodiments can be appropriately combined with other embodiments, modifications, and conventional techniques.

A problem to be solved by the present disclosure is to provide a support technology capable of improving efficiency of use of information regarding legal affairs.

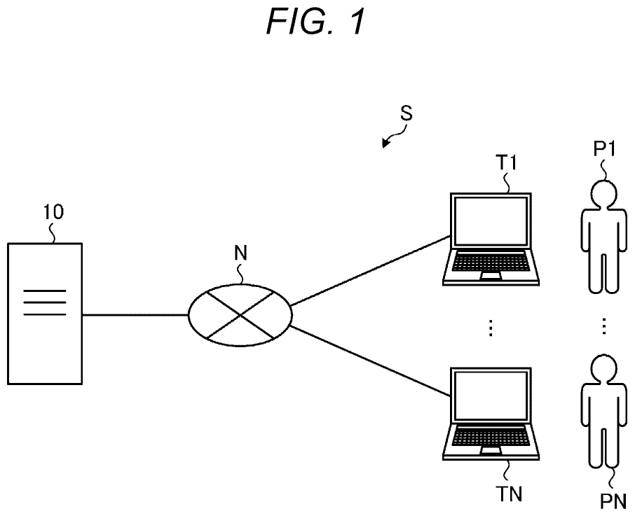

FIG. 1 is a schematic diagram for explaining an outline of an information processing system S according to the present embodiment. As illustrated in FIG. 1, the information processing system S of the present embodiment may include, for example, an information processing device 10 and at least one of terminal devices T1 to TN that can communicate via a network N with the information processing device 10 according to the embodiment. The terminal devices T1 to TN are operated by users P1 to PN, respectively. Note that the terminal devices T1 to TN will be described by taking a configuration of the terminal device T1 as an example.

Here, the information processing system S according to the present embodiment may be, for example, a system that supports creation of a matter outline of a legal matter on a browser of the terminal device T1.

In the present specification, a legal matter may be a unit of a set of legal affairs, and may be, for example, a unit in which a legal staff of a company is requested to examine and prepare a contract or a legal document. The unit of the legal matter may be, for example, each request or each contract. Furthermore, for example, a set of conversations or any given data may be a unit, such as a channel or a thread of a social networking service (SNS), a thread of e-mails, or a matter registered in a system. Furthermore, the unit of the legal matter may be determined by a rule such as a regulation or a policy of a company to which a user belongs, an individual user, setting of a vendor that provides the system, or the like. In addition, it may be preferable that each legal matter can be specified by, for example, a matter number, a matter name, a client name, or the like. Hereinafter, information that can specify the legal matter is simply referred to as matter information.

In the present embodiment, the matter outline of the legal matter may include at least two sentences, a “summary” and a “topic”. The “summary” can be a background of the legal matter, particularly a past background. The “topic” can be an item regarding examination including modification of a legal document related to the legal matter. Specific examples of the “summary” and the “topic” will be described later. The “summary” is an example of a first sentence in the present embodiment. Furthermore, the “topic” is an example of a second sentence in the present embodiment. Note that, in the present specification, a sentence may include very short information such as only one word, only one sentence, or a bulleted list, in addition to a plurality of sentences.

In the present specification, a document may mean a document in any language, created according to a certain rule or standard such as a certain rule, law, or custom. In addition, in the present specification, legal documents include contract documents, general conditions, and other legal documents in general. Furthermore, the legal documents handled by the information processing system S may be described in any language.

The information processing system S of the present embodiment can receive an input of text data related to a legal matter, and can generate and output a matter outline of the legal matter from the text data.

The text data may be any data as long as text information is included, and may be in any form. In the present embodiment, the text data input to the information processing system S may be, for example, body text of an e-mail. In addition, a mode of the text data may be, for example, writing into the information processing system, posting on an in-house bulletin board, posting on a chat tool such as Slack (registered trademark), a document created by editor software, text data in another format, or the like. In order to generate an appropriate matter outline, the text data may be preferably data including negotiation with the other party of the contract. Since an e-mail is often used for interaction in negotiation with the other party, an e-mail or text data obtained by importing information of the e-mail may be considered to include description regarding a past background and a gist of amendment in many cases, and may be preferable as a sentence of a source of a summary. Furthermore, in particular, an e-mail may often include a relatively large amount of wording that is not directly related to content of the matter, such as greetings and signatures, as compared to other tools. Therefore, when a person in charge looks back to grasp the background of the legal matter later, an amount of text is larger than an amount of information to be obtained, and a burden of the work of looking back may be high. For this reason, summarizing the e-mail as the matter outline may have a high degree of contribution to improvement of operation efficiency. Note that the text data in the present specification may also include tabular data. Furthermore, the text data of the present specification may include text in a comment in a text file generated by word processing software. Specifically, text in files related to legal documents (for example, a contract document) or other legal matters exchanged with the other party, or a comment in a file created by a function such as Microsoft Word (registered trademark) can also be used as text data for generating the matter outline. Note that, in the present embodiment, the term “mail” may include not only text data in a data format dedicated to e-mails (for example, data with the extension “.eml”) but also text data in which content of the mail is described and text data obtained by extracting a part of the content of the mail.

The terminal device T1 of the present embodiment may be a client device managed by the user P1 who uses a creation support service for a matter outline of a legal matter. The user P1 may be, for example, a legal staff. The terminal device T1 can display a matter outline of a legal matter including a “summary” and a “topic” on a screen of a display device, on the basis of information from the information processing device 10, for example.

Note that the information processing system S may have a function other than creation support for a matter outline of a legal matter. For example, the information processing device 10 of the information processing system S may have a text data accumulation function such as storage management of legal documents or management of transmission and reception of e-mails. In this case, users P1 to PN may access the information processing device 10 from the terminal devices T1 to TN via the network N, to store a legal document in the information processing device 10, transmit and receive e-mails using a function provided by the information processing device 10, exchange messages using a chat function in the system, or accumulate text data in the system through interaction in a chat tool in cooperation with the system.

Furthermore, the information processing system S according to the present embodiment can include a document creation support function and a document browsing function. Here, the document creation support function may provide a function of editing (modifying, adding, deleting, and the like) content of a legal document and information for supporting editing. Furthermore, the information processing system S according to the present embodiment may use information regarding editing of a legal document (for example, an amendment history of rewriting of wording added to a contract document, a comment given to the document, and the like) as text data, for example, for generating a “topic”. In addition, the document browsing function may be to support browsing (display) of a document on a terminal device.

A service (document browsing support service) provided by the document browsing function of the information processing system S according to the present embodiment can include, for example, at least one of: executing document review processing on a legal document on a web browser and providing a result thereof to a user; executing document editing in response to an instruction from the user; storing an edited document or providing the edited document to the user; editing additional information (for example, meta-information, comment information, chat information, or format information) associated with the legal document; creating a new document (including a copy); comparing a plurality of documents (for example, clearly indicating difference information); automatically proofreading the legal document; and executing various types of processing using a translation display function.

In addition, in the present specification, the document review processing may be, for example, processing of analyzing or evaluating information included in a legal document on the basis of a certain standard and outputting a result thereof. For example, the document review processing may include checking and examining whether or not information included in a legal document is appropriate on the basis of a certain standard. Specifically, the document review processing may include, for example, matching between wording in a document and a check list prepared in advance and outputting a result of matching or an indication included in the check list. In addition, editing may mean, for example, adding, deleting, or changing information included in an editing target.

Next, specific configurations of the information processing device 10 and the terminal device T1 of the present embodiment will be described.

### Hardware Configuration of Information Processing Device 10

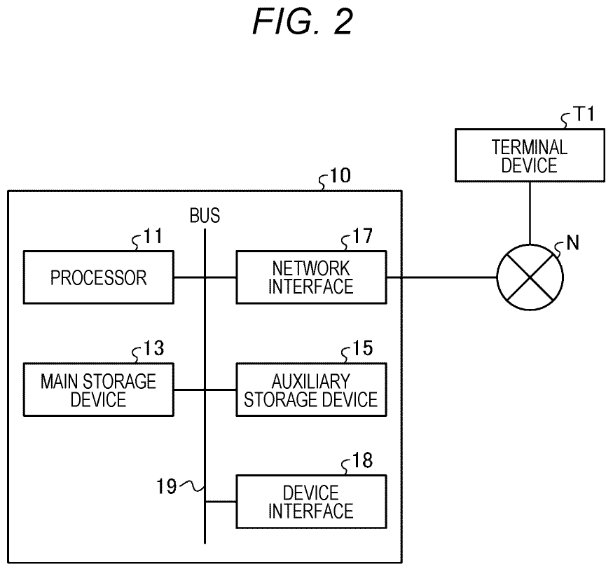

FIG. 2 is a block diagram illustrating an example of a hardware configuration of the information processing device 10 according to the embodiment. The information processing device 10 of the present embodiment may be a device that is connected to the terminal devices T1 to TN by communication and can perform various types of processing in response to requests from the terminal devices T1 to TN. The information processing device 10 may be managed by, for example, a company side that provides the creation support service for a matter outline of a legal matter. For example, in response to an instruction of matter outline generation of a legal matter received from the terminal device T1 as a client device via the network N, the information processing device 10 may provide the terminal device T1 with the creation support service for the matter outline of the legal matter.

As illustrated in FIG. 2, the information processing device 10 of the present embodiment may be a computer, and may include, as an example, a processor 11, a main storage device (memory) 13, an auxiliary storage device (storage) 15, a network interface 17, a device interface 18, and a bus 19 that connects the components to each other.

The information processing device 10 of the present embodiment illustrated in FIG. 2 may include one of each component, but may include a plurality of the same components. In addition, one information processing device 10 may be illustrated in FIG. 2, but software may be installed in a plurality of computers, and each of the plurality of computers may execute the same part or different parts of processing of the software. In this case, the information processing device 10 may be in a form of distributed computing in which each of the computers communicates via the network interface 17 or the like to execute processing. That is, the information processing device 10 in the present embodiment may be configured as a system that implements various functions described later by one or a plurality of computers executing commands stored in one or a plurality of storage devices.

Various computations of the information processing device 10 of the present embodiment may be executed in parallel processing using one or a plurality of processors 11 or using a plurality of computers via a network. In addition, various computations may be distributed to a plurality of computing cores in the processor 11 and executed in parallel processing. In addition, a part or the whole of the processing, means, and the like of the present disclosure may be executed by at least one of a processor and a storage device provided on a cloud capable of communicating with the information processing device 10 via a network. As described above, the processing of the information processing system S in the present embodiment may be in a form of parallel computing by one or a plurality of computers.

The processor 11 may be an electronic circuit (a processing circuit, a processing circuitry, a central processing unit (CPU), a graphics processing unit (GPU), a field programmable gate array (FPGA), an application specific integrated circuit (ASIC), or the like) including a control device and a computing device of the information processing device 10. In addition, the processor 11 may be a semiconductor device or the like including a dedicated processing circuit. The processor 11 may be achieved by an optical circuit using an optical logic element without being limited to an electronic circuit using an electronic logic element. In addition, the processor 11 may include a computing function based on quantum computing.

The processor 11 can perform computing processing on the basis of data and software (program) input from each device or the like of an internal configuration of the information processing device 10, and can output a computation result and a control signal to each device or the like. The processor 11 may control each component constituting the information processing device 10 by executing an operating system (OS) of the information processing device 10, an application, or the like.

The information processing device 10 in the present embodiment may be achieved by one or a plurality of processors 11. Here, the processor 11 may refer to one or a plurality of electronic circuits disposed on one chip, or may refer to one or a plurality of electronic circuits disposed on two or more chips or two or more devices. When a plurality of electronic circuits are used, the electronic circuits may communicate in a wired or wireless manner.

The main storage device 13 of the present embodiment may be a storage device that stores commands executed by the processor 11, various types of data, and the like, and information stored in the main storage device 13 may be read by the processor 11. The auxiliary storage device 15 may be a storage device other than the main storage device 13, and can include, for example, a storage medium such as a hard disk drive (HDD) or a flash memory. Note that each of these storage devices may mean any electronic component capable of storing electronic information, and may be a semiconductor memory. The semiconductor memory may be either a volatile memory or a nonvolatile memory. A storage device for storing various types of data used in the information processing device 10 according to the present embodiment may be achieved by the main storage device 13 or the auxiliary storage device 15, or may be achieved by a built-in memory built in the processor 11. For example, the main storage device 13 and the auxiliary storage device 15 may be collectively referred to as a storage unit or a storage device.

In a case where the information processing device 10 has a function of storing and managing legal documents, managing transmission and reception of e-mails, or the like, the auxiliary storage device 15 may store, for example, legal documents transmitted from the terminal devices T1 to TN via the network N, e-mails transmitted and received in the past, or the like.

In addition, the auxiliary storage device 15 may store a trained model capable of summarizing text data. The trained model of the present embodiment may be a trained model called generative artificial intelligence (AI) or the like, and may be, for example, a language model or a large language model (LLM). The large language models may include, for example, bidirectional encoder representations from transformers (BERT), a generative pre-trained transformer (GPT), and the like, and particularly include ChatGPT or GPT-4. Note that the trained model may be present outside the information processing device 10. For example, the trained model may be present outside the information processing device 10, for example, in an external server connected to the information processing device 10 via the network N. In this case, a matter outline generation unit 113 may input text data to the trained model of the external server via the network N, and acquire an output from the trained model via the network N. Furthermore, the trained model may be present in a server device or the like outside the information processing system S.

A plurality of processors 11 may be connected (coupled) or a single processor 11 may be connected to one storage device (the main storage device 13 and/or the auxiliary storage device 15). A plurality of storage devices may be connected (coupled) to one processor 11. When the information processing device 10 in the present embodiment includes at least one storage device and a plurality of processors connected (coupled) to the at least one storage device, at least one processor among the plurality of processors may be connected (coupled) to the at least one storage device. In addition, this configuration may be achieved by a storage device included in a plurality of computers and the processor 11. Furthermore, a storage device may be integrated with the processor 11 (for example, a cache memory including an L1 cache and an L2 cache).

The network interface 17 of the present embodiment may be an interface for connecting to the network N in a wireless or wired manner. As the network interface 17, it is only required to use an appropriate interface such as one conforming to an existing communication standard. The network interface 17 may exchange information with an external device connected via the network N. Note that the network N may be any of a wide area network (WAN), a local area network (LAN), a personal area network (PAN), and the like, or may be a combination thereof, and may only need to be one that allows exchange of information between the information processing device 10 and an external device. Examples of the WAN may include the Internet, examples of the LAN include IEEE802.11 and Ethernet (registered trademark), and examples of the PAN include Bluetooth (registered trademark) and near field communication (NFC).

The device interface 18 of the present embodiment may be an interface such as a universal serial bus (USB) directly connected to an output device such as a display device, an input device, and an external device. In addition, the external device may be a storage such as a storage device (memory), a network storage, or an HDD. In addition, the external device may be a device having some functions of components of the information processing device 10 in the present embodiment. That is, the information processing device 10 may transmit or receive a part or the whole of a processing result of the external device. The display device connected to the device interface 18 may be, for example, a liquid crystal display (LCD), a cathode ray tube (CRT), a plasma display panel (PDP), an organic electro luminescence (EL) panel, or the like. As the input device connected to the device interface 18, for example, various input interfaces such as a keyboard, a mouse, and a touch pad can be applied. Furthermore, an output device such as a display device and an input device may be included in the information processing device 10.

### Hardware Configuration of Terminal Device T1

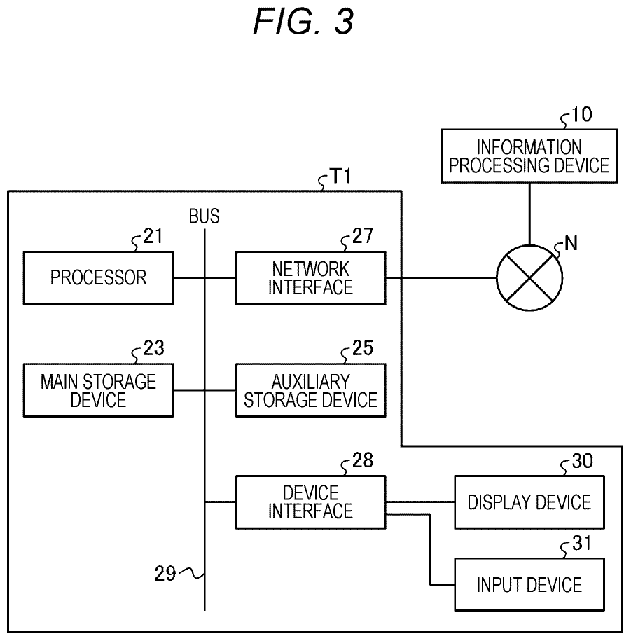

FIG. 3 is a block diagram illustrating an example of a hardware configuration of the terminal device T1 according to the present embodiment. The terminal device T1 of the present embodiment can display various operation screens generated by the information processing device 10 and a matter outline of a legal matter, in the creation support service for a matter outline of a legal matter. Furthermore, the terminal device T1 may transmit information regarding an operation by the user P1 to the information processing device 10.

As illustrated in FIG. 3, the terminal device T1 may be a computer, and include, as an example, a processor 21, a main storage device (memory) 23, an auxiliary storage device (storage) 25, a network interface 27, a device interface 28, a bus 29 that connects the components to each other, a display device 30 connected to the device interface 28, and an input device 31 connected to the device interface 28. Note that specific hardware configurations of the processor 21, the main storage device 23, the auxiliary storage device 25, the network interface 27, the device interface 28, and the bus 29 may be similar to those of the processor 11, the main storage device 13, the auxiliary storage device 15, the network interface 17, the device interface 18, and the bus 19, respectively, and therefore description thereof may be omitted. The terminal device T1 may be specifically a personal computer (PC), a tablet terminal, or the like, but is not limited thereto.

The display device 30 may be a display device such as an LCD, a CRT, a PDP, or an organic EL panel. The display device 30 may display, for example, a matter display screen, a matter outline edit screen, and the like to be described later, on the basis of an instruction from the processor 21.

The input device 31 may be a device such as a keyboard, a mouse, or a touch panel. The user P1 can input various editing instructions, for example, in the document editing processing by using the input device 31. The instruction input from the input device 31 may be sent to the processor 21.

Note that the terminal device T1 may include another external device (for example, a camera, a microphone, a motion capture, or various sensors) connected via the device interface 18 in order to operate and edit text data.

### Functional Configuration of Information Processing Device 10

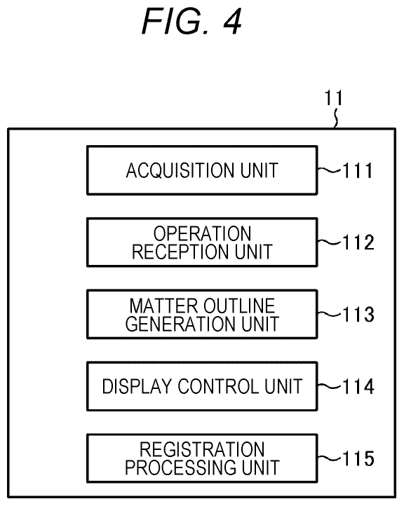

Next, a functional configuration of the information processing device 10 will be described. FIG. 4 is a diagram illustrating an example of functional blocks of the information processing device 10 according to the present embodiment. The information processing device 10 may include, for example, an acquisition unit 111, an operation reception unit 112, the matter outline generation unit 113, a display control unit 114, and a registration processing unit 115, as functions implemented by the processor 11. Each of the functions implemented by the acquisition unit 111, the operation reception unit 112, the matter outline generation unit 113, the display control unit 114, and the registration processing unit 115 may be stored as a program in, for example, the main storage device 13, the auxiliary storage device 15, or the like. The processor 11 can implement various functions (the acquisition unit 111, the operation reception unit 112, the matter outline generation unit 113, the display control unit 114, and the registration processing unit 115) by reading and executing the program stored in the main storage device 13, the auxiliary storage device 15, or the like.

The acquisition unit 111 of the present embodiment may acquire text data related to a legal matter. As described above, the text data in the present embodiment may be any data as long as text information is included, and may be in any form.

For example, as a method of acquiring text data, in a case where the auxiliary storage device 15 of the information processing device 10 stores text data in advance, the acquisition unit 111 may search for and acquire only text data related to a matter as a matter outline generation target from the stored text data, by using, as a search condition, matter information or the like of the legal matter as a matter outline generation target. In addition, the acquisition unit 111 may acquire text data from the terminal device T1 via the network N. For example, a display device of the terminal device T1 may display a text data input field provided on a browser by the display control unit 114 to be described later, and the user P1 may input text data into the text data input field. Alternatively, the terminal device T1 may store an electronic file of the text data via the network N by the operation of the user P1, into a predetermined folder provided in the auxiliary storage device 15 of the information processing device 10. Alternatively, a mail or a short message service (SMS) message may be received via the network N, and text data in the message may be acquired.

The operation reception unit 112 of the present embodiment can receive an operation by the user P1 from the terminal device T1 via the network N. For example, when the user P1 presses an image button provided on the browser by the display control unit 114 to be described later and indicating generation of a matter outline, the operation reception unit 112 may receive the operation of the user P1.

The matter outline generation unit 113 of the present embodiment may input text data related to a legal matter to the trained model, and cause the trained model to output a matter outline of the legal matter. Specifically, the matter outline generation unit 113 can input text data acquired by the acquisition unit 111 to a large language model. The large language model in the present embodiment may be stored in, for example, a server device or the like outside the information processing system S.

As described above, in the present embodiment, the matter outline of the legal matter may include at least two sentences, a “summary” and a “topic”. Therefore, the matter outline generation unit 113 of the present embodiment may input, together with the text data, a prompt for instructing the trained model to generate two sentences, the “summary” and the “topic”, from the text data.

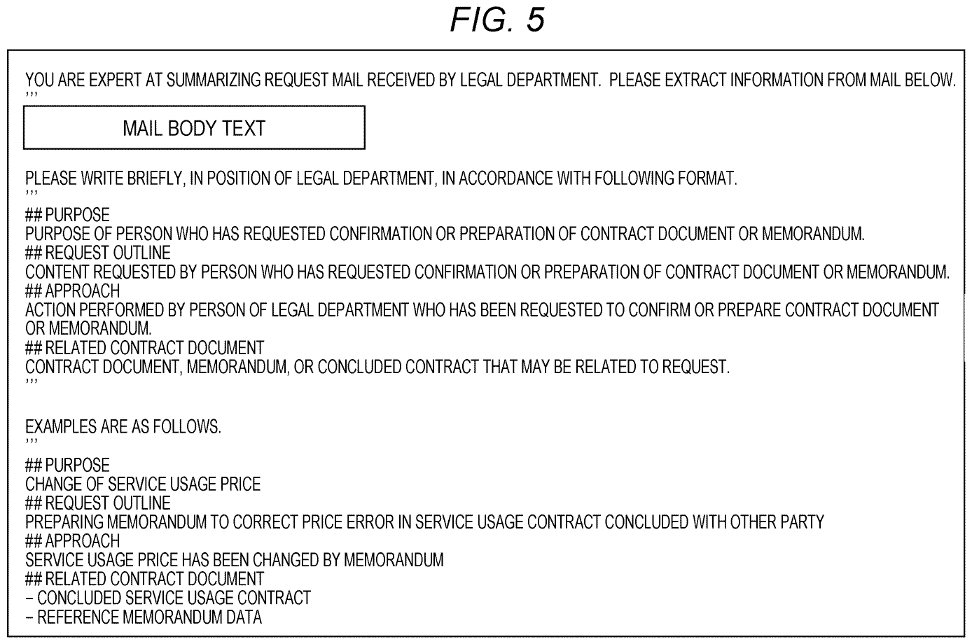

FIG. 5 is an example of a prompt for “summary” generation according to the present embodiment. As described above, the “summary” may be a past background of a legal matter. The prompt for “summary” generation may be an example of a first prompt in the present embodiment. Note that the prompt illustrated in FIG. 5 may be disclosed to the user P, or may be only used via the system without being disclosed.

As illustrated in FIG. 5, the prompt for “summary” generation in the present embodiment may include a plurality of categories included in the “summary” and at least one example for each of the plurality of categories. Examples of the plurality of categories include “purpose”, “request outline”, “approach”, and “related contract document”. In the example illustrated in FIG. 5, the prompt for “summary” generation may also include a sentence describing each of the plurality of categories. The description of the “purpose” may be “a purpose of the person who has requested confirmation or preparation of a contract document or a memorandum”. The description of the “request outline” may be “content requested by the person who has requested confirmation or preparation of a contract document or a memorandum”. The description of the “approach” may be “an action performed by a person of the Legal Department who has been requested to confirm or prepare a contract document or a memorandum”. The description of the “related contract document” may be “a contract document, a memorandum, or a concluded contract that may be related to the request”. Note that this category is named “related contract document”, but may include legal documents other than contract documents. By including a topic (category) of an extraction target and an example in this manner, data of the “summary” can be appropriately obtained using the large language model.

An example of the “purpose” may be “a change of a service usage price”. An example of the “request outline” may be “preparing a memorandum to correct a price error in the service usage contract concluded with the other party”. An example of the “approach” may be “a service usage price has been changed by the memorandum”. Examples of the “related contract document” may be “concluded service usage contract” and “reference memorandum data”.

In addition, the prompt for “summary” generation in the present embodiment may include a sentence describing input text data for the large language model. The description described before the input of text data in the prompt may be, for example, “You are an expert at summarizing xx of the Legal Department. Please extract information from xx below”, in which a type of text data to be input is described in “xx”. In the example illustrated in FIG. 5, body text of an e-mail is input as text data after wording “You are an expert at summarizing a request mail received by the Legal Department. Please extract information from the request mail below”. For example, the matter outline generation unit 113 can input text data to the trained model by inputting text data such as body text of an e-mail acquired by the acquisition unit 111 to the input field. Note that one e-mail or a plurality of e-mails may be input to the trained model. For example, in a case where e-mails transmitted and received in the past are stored in the auxiliary storage device 15 in advance in association with matter information or the like, the matter outline generation unit 113 may input, to the trained model, body text of the plurality of e-mails associated with matter information or the like of a target of matter outline generation. Furthermore, the text data may include not only body text of an e-mail but also an attached file. Note that the description indicating the type of text data in the prompt may be changeable by the user P. In a case where the prompt is not disclosed to the user P, for example, a screen on which “type of text data” and “text data” can be input may be displayed on the browser of the terminal device T1 by the display control unit 114 described later.

In a case where the number of characters in the text data related to the matter that is a target of matter outline generation exceeds the number of characters that can be input to the trained model at one time, the matter outline generation unit 113 may divide the text data by the number of characters that can be input to the trained model at one time and input the divided text data to the trained model, and then input a prompt for instructing to integrate the input text data to the trained model. In addition, processing of reducing the number of characters or a data size of text data of a summary or the like may be performed in advance by another or the same trained model or the like, and then the text data may be input to the trained model to obtain a matter outline of a legal matter.

Note that each of the input of the category, the example, and wording to be described before the text data illustrated in FIG. 5 is an example. For example, the category and the content of the example may be customized to be different for each of the users P1 to PN or an organization to which the user belongs, to which the creation support service for the matter outline of the legal matter is provided. As a result, it is possible to obtain a matter outline of a legal matter according to needs of the user. Furthermore, in a case where data other than body text of an e-mail is input as text data, a plurality of types of wording to be described before the input of the text data may be prepared in accordance with a format of the text data. For example, a portion of “request mail” in the wording described above may be “request”.

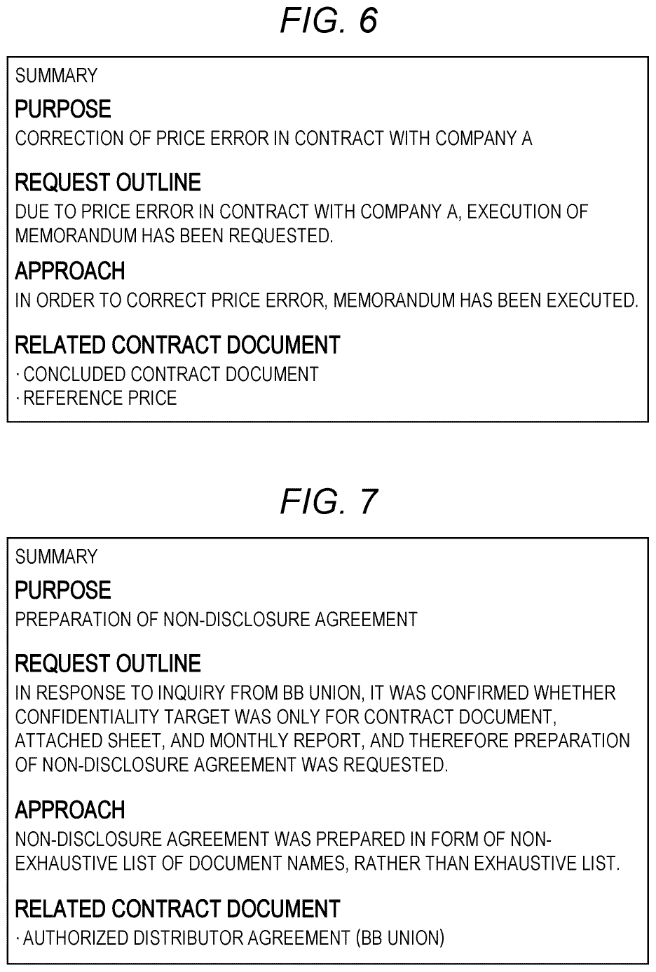

FIG. 6 is an example of a “summary” generated by the prompt of FIG. 5. In the present embodiment, the matter outline generation unit 113 can input text data and the prompt for “summary” generation illustrated in FIG. 5 to the trained model, so that the trained model can output the “summary” illustrated in FIG. 6. As illustrated in FIG. 6, in the “summary” output from the trained model, sentences generated on the basis of text data may be listed for each of the plurality of categories included in the prompt for “summary” generation.

For example, in the example illustrated in FIG. 6, the category “purpose” may be described as “correction of a price error in a contract with Company A”. In addition, “due to a price error in the contract with Company A, execution of a memorandum has been requested” may be described in the category “request outline”. In addition, “in order to correct the price error, the memorandum has been executed” is described in the category “approach”. Further, in the category “related contract document”, names of documents such as “concluded contract document” and “reference price” may be described.

Note that, in the “related contract document”, a link destination such as a uniform resource locator (URL) of a storage destination of a contract document related to the target legal matter or a file name of the contract document may be described. In addition, in a case where there are a plurality of related contract documents, the trained model may classify link destinations or file names of the contract document by, for example, a type of contract document or a type of document and output the link destinations or the file names. In addition, when there are multiple versions of a contract document related to the target legal matter, only the latest version may be displayed in the “related contract document”, or different versions, for example, two of the first version and the latest version may be displayed. As described above, the “related contract document” may not be limited to a contract document, and may include a document related to the legal matter that is a target of matter outline generation, for example, reference information such as laws and guidelines. In addition, a price list, a specification, and the like may be described as “related information” similarly to the “related contract document”.

FIG. 7 is another example of a “summary” generated by the prompt of FIG. 5. FIG. 7 illustrates a “summary” output from a trained model to which text data different from the example illustrated in FIG. 6 has been input. As illustrated in FIGS. 6 and 7, content described in each category of a matter outline output from the trained model may differ depending on content of the text data input to the trained model.

Hereinafter, an example of a prompt for “topic” generation according to the present embodiment will be described. In the present embodiment, the “topic” may be an item regarding modification of a legal document. The prompt for “topic” generation may be an example of a second prompt in the present embodiment. Note that the prompt may be disclosed to the user P, or may be only used via the system without being disclosed.

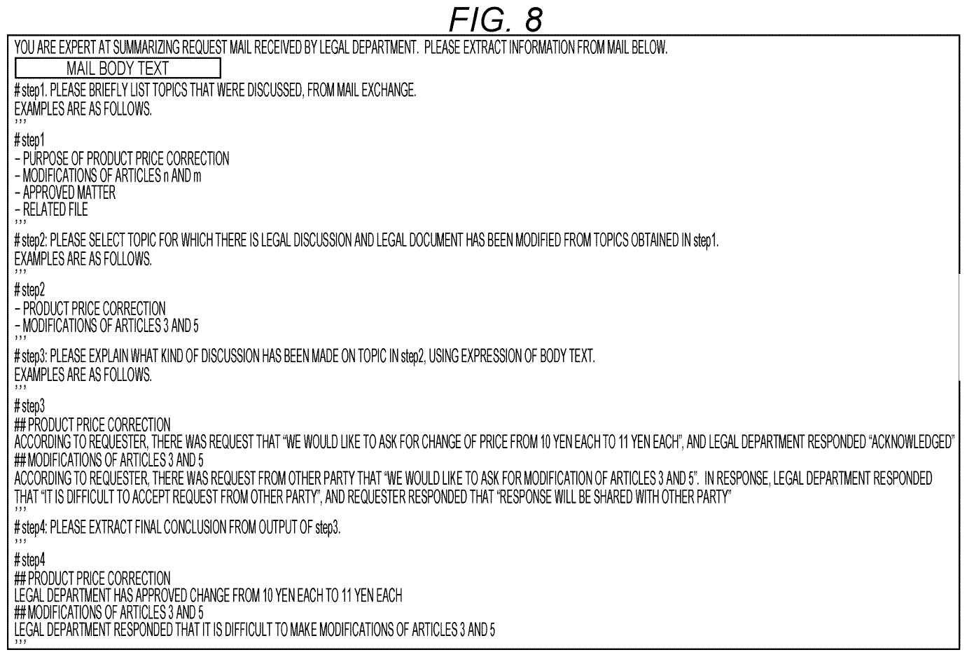

As illustrated in FIG. 8, the prompt for “topic” generation in the present embodiment may preferably include a plurality of steps. First to fourth steps of the present embodiment may each include a statement for the trained model and an output example. As described above, by causing the large language model to process text data through the plurality of steps and with the output example, information of the “topic” can be appropriately output by the large language model.

The first and second steps may be, for example, steps of extracting items regarding modification of a legal document step by step from input text data. In the first step, for example, without limiting to items related to the legal document, a topic that has been discussed may be extracted from the text data. Then, in the second step, only a topic related to modification of the legal document may be extracted with respect to the result extracted in the first step. By extracting items step by step from the input text data in this manner, it is possible to accurately extract items regarding modification of the legal document. More specifically, the prompt for “topic” generation may include the first step and the second step, thereby reducing extraction of topics other than the items regarding modification of the legal document, and reducing omission of extraction of the items regarding modification of the legal document.

Specifically, the prompt in the first step may include a statement “please provide a concise list of discussed topics, from mail exchange” and an output example of the discussed topics. In the present embodiment, for example, as an output result of the first step, “purpose of product price correction”, “modifications of Articles n and m”, “approved matter”, and “related file” may be output as examples of topics that have been discussed.

The prompt of the second step may include a statement “please select a topic for which there is a legal discussion and the legal document has been modified from the topics obtained in step 1” and an output of the topic with modification applied to the legal document. The output examples listed in the second step may be more specific than the examples listed in the first step. In the present embodiment, “product price correction” and “modifications of Articles 3 and 5” may be output as outputs of the second step. While the article number such as “Articles n and m” is not specified in the first step, a specific article number may be output in the second step.

The third and fourth steps may extract a discussion and a conclusion thereof related to the topics extracted in the first to second steps. More particularly, the third step may extract a discussion related to the topics extracted in the second step from the input text data. The fourth step may extract only a final conclusion from the results of the third step.

Specifically, the third step may include, for example, a statement “please explain what kind of discussion has been made on the topic in step 2, using expression of body text” and an output example of the discussion related to the topic extracted in the second step. In the present embodiment, as the third step, a sentence “according to the requester, there was a request that ‘we would like to ask for a change of the price from 10 yen each to 11 yen each’, and the Legal Department responded ‘acknowledged’” may be output for the topic of “product price correction”. Furthermore, a sentence “according to the requester, there was a request from the other party that ‘we would like to ask for modifications of Articles 3 and 5’. In response, the Legal Department responded that ‘it is difficult to accept the request from the other party’, and the requester responded that ‘the response will be shared with the other party’” may be output for the topic “modifications of Articles 3 and 5”.

The fourth step may include a statement “please extract a final conclusion from the output of Step 3” and an output example of a final conclusion corresponding to the topic extracted in the second step. In the present embodiment, a sentence “the Legal Department has approved the change of the price from 10 yen each to 11 yen each” may be output for the topic “product price correction”. Furthermore, a sentence “the Legal Department responded that it is difficult to make modifications of Articles 3 and 5” may be output for the topic “modifications of Articles 3 and 5”. In this manner, by generating an explanatory sentence of a discussion related to each topic step by step in the third and fourth steps, accuracy of the output matter outline can be improved.

Furthermore, in the example illustrated in FIG. 8, the prompt for “topic” generation may include a text data input field, similarly to the prompt for “summary” generation illustrated in FIG. 5. Note that, in FIGS. 5 and 8, the text data input field may be provided in each of the prompt for “summary” generation and the prompt for “topic” generation, but one text data input field may be shared in the prompt for “summary” generation and the prompt for “topic” generation.

Note that the steps included in the prompt for “topic” generation may not be limited to the above example. For example, the prompt for “topic” generation may further include other steps. The prompt for “topic” generation may preferably include at least the first step and the second step. As a result, the matter outline can be appropriately generated using the large language model.

In addition, the example included in each step is an example, and is not limited to the above. The content of the example may be customized to be different for each of the users P1 to PN. Furthermore, in a case where data other than body text of an e-mail is input as text data, a plurality of types of wording to be described before the input of the text data may be prepared in accordance with a format of the text data. Furthermore, as described in the description of FIG. 5, the description indicating the type of text data in the prompt may be changeable by the user P. In a case where the prompt is not disclosed to the user P, for example, a screen on which “type of text data” and “text data” can be input may be displayed on the browser of the terminal device T1 by the display control unit 114 described later.

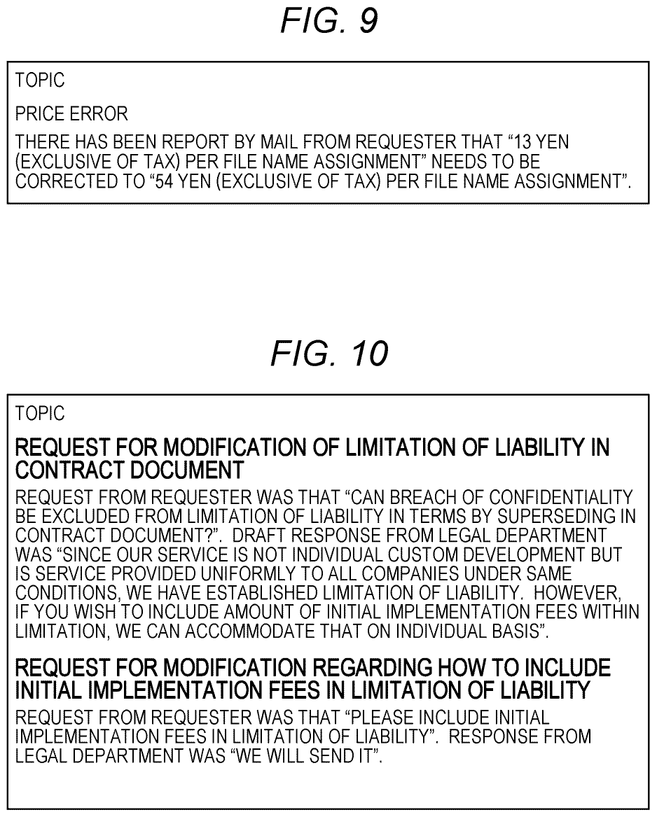

FIG. 9 is an example of a “topic” generated by the prompt of FIG. 8. The matter outline generation unit 113 can input text data and the prompt for “topic” generation illustrated in FIG. 8 to the trained model, so that the trained model can output the “topic” illustrated in FIG. 9. As illustrated in FIG. 9, the “topic” output from the trained model of the present embodiment may include a title of an item regarding modification of a legal document and an explanatory sentence of content of the item. The title of the item regarding modification of the legal document may be, for example, the topic extracted in the second step described above. Further, the explanatory sentence of the content of the item regarding modification of the legal document may be the conclusion generated in the fourth step described above. In the example illustrated in FIG. 9, the title of the item regarding modification of the legal document may be “price error”, and the explanatory sentence of the item may be “there has been a report by a mail from the requester that ‘13 yen (exclusive of tax) per file name assignment’ may need to be corrected to ‘54 yen (exclusive of tax) per file name assignment’”.

FIG. 10 is another example of a “topic” generated by the prompt of FIG. 8. FIG. 10 illustrates a “topic” output from a trained model to which text data different from the example illustrated in FIG. 9 has been input. As illustrated in FIGS. 9 and 10, content described in each category of a matter outline output from the trained model may differ depending on content of the text data input to the trained model.

Returning to FIG. 4, the display control unit 114 may cause the display device 30 of the terminal device T1 to display various screens, for example, by performing information communication with the terminal device T1 via the network N.

Specifically, the display control unit 114 of the present embodiment can generate display information for displaying a matter outline of a legal matter, and can output the display information to the terminal device T1. Note that the display information may include layout information. In the present embodiment, the display control unit 114 can output, to the terminal device T1, layout information defining a screen layout for displaying a matter outline of a legal matter in the browser, and text data and image data to be displayed on the screen. A format of the layout information and the data transmitted from the display control unit 114 to the terminal device T1 may be, for example, a format that can be executed by a general web browser, and may be hyper text markup language (HTML) data, a script (for example, Java (registered trademark) Script), or the like. Note that, as a technique by which the display control unit 114 may cause the display device 30 of the terminal device T1 to display various screens, for example, a dedicated application may be installed in the terminal device T1. Note that the display control unit 114 may be referred to as a screen generation unit.

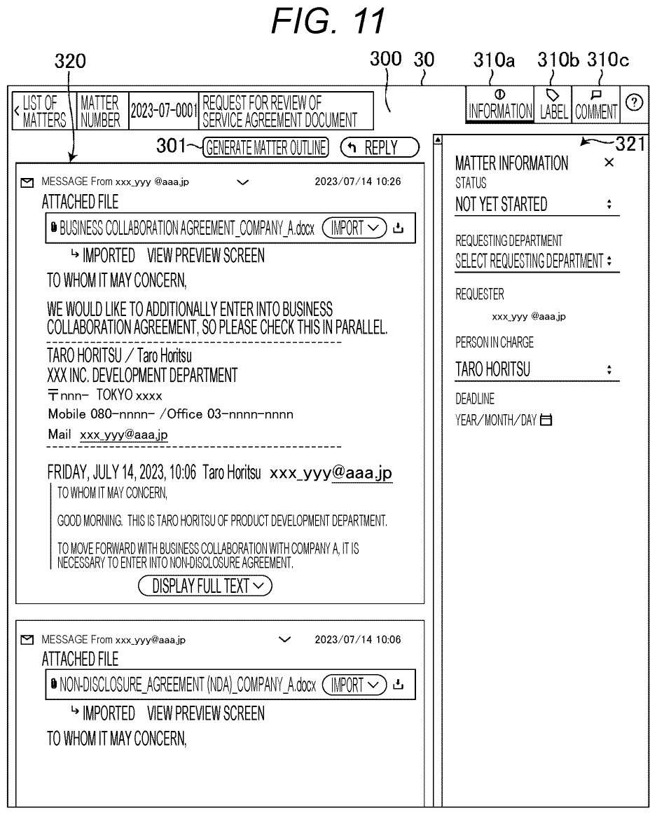

Here, examples of various screens displayed on the display device 30 of the terminal device T1 by the display control unit 114 will be described with reference to FIGS. 11 to 13.

FIG. 11 is a diagram illustrating an example of a matter display screen 300 according to the present embodiment. The matter display screen 300 of the present embodiment may be a screen on which information regarding a legal matter is displayed. For example, the display control unit 114 can generate one matter display screen 300 for each legal matter. The example illustrated in FIG. 11 may be the matter display screen 300 on which information associated with a matter number “2023-07-0001” is displayed.

The matter display screen 300 may include, for example, a text data display area 320 and a tab display area 321. The display control unit 114 can display text data related to the legal matter in the text data display area 320. In FIG. 11, body text of an e-mail may be displayed in the text data display area 320 as an example. Further, the matter display screen 300 may include a plurality of tabs 310a to 310c. Hereinafter, each of the tabs 310a to 310c may be simply referred to as a tab 310 when the tabs 310a to 310c are not distinguished from each other. The display control unit 114 may display, in the tab display area 321, content of one tab 310 selected by the user P1 among the tabs 310a to 310c, for example. In the example illustrated in FIG. 11, content of the “information” tab 310a may be displayed in the tab display area 321. The “information” tab 310a may be a tab that displays matter information, which is various types of information regarding the legal matter, and displays, for example, a status of the legal matter, a requesting department, a requester, a person in charge, a deadline of the response, and the like. Note that these pieces of information may be stored in the auxiliary storage device 15 in association with, for example, the matter information or the like. The tabs 310a to 310c may be examples of a plurality of screen areas in the present embodiment.

In addition, the display control unit 114 of the present embodiment can display a matter outline generation button 301 on the matter display screen 300. The matter outline generation button 301 may be a button image capable of receiving an instruction of matter outline generation from the user. The matter outline generation button 301 may be an example of a reception unit in the present embodiment. When the user P1 presses the matter outline generation button 301, that is, when the matter outline generation button 301 receives an instruction of matter outline generation from the user P1, the matter outline generation unit 113 can input text data, a prompt for “summary” generation, and a prompt for “topic” generation to the trained model, and generate a “summary” and a “topic”. Note that, in the present specification, the button may be an example of a UI that is operated by the user to issue any given instruction. Examples of such a UI include a drop-down list and the like.

The display control unit 114 can output the “summary” and the “topic” generated by the matter outline generation unit 113. In the present embodiment, the display control unit 114 may display the generated “summary” and “topic” in an editable manner.

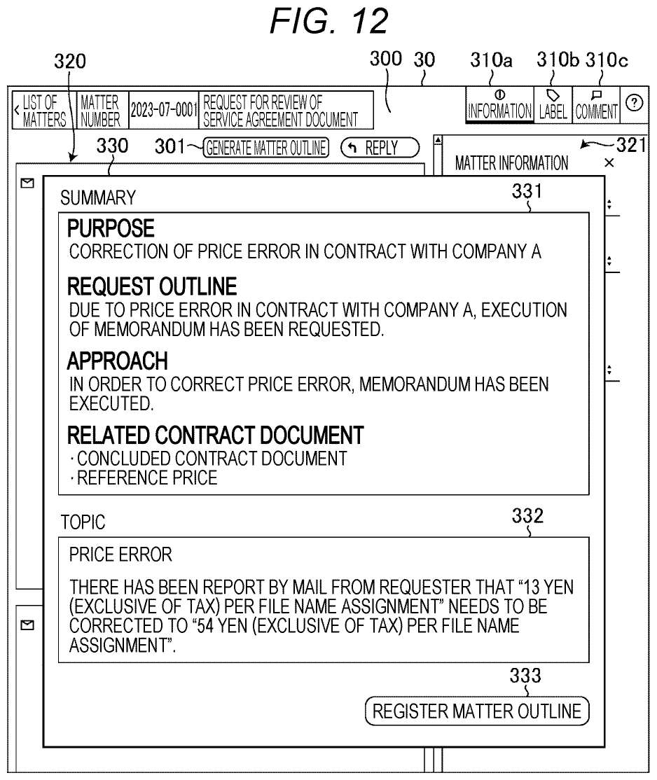

FIG. 12 is a diagram illustrating an example of a matter outline edit screen 330 according to the present embodiment. As illustrated in FIG. 12, the display control unit 114 of the present embodiment may show the matter outline edit screen 330 as a pop-up on the matter display screen 300. The matter outline edit screen 330 can include a “summary” edit field 331, a “topic” edit field 332, and a registration button 333.

The “summary” edit field 331 and the “topic” edit field 332 of the present embodiment may be screen areas in which a “summary” and a “topic” generated by the matter outline generation unit 113 are displayed in an editable manner, respectively. The user P1 can confirm the “summary” and the “topic” displayed in the “summary” edit field 331 and the “topic” edit field 332, and can edit the sentence as necessary.

The registration button 333 of the present embodiment may be a button image capable of receiving an operation by the user P1 to confirm and store the “summary” and the “topic” displayed in the “summary” edit field 331 and the “topic” edit field 332.

When the registration button 333 is pressed, the registration processing unit 115 of the information processing device 10 according to the present embodiment may store the “summary” and the “topic” displayed in the “summary” edit field 331 and the “topic” edit field 332, for example, into the auxiliary storage device 15 of the information processing device 10. The display control unit 114 can display the confirmed “summary” and “topic” as a matter outline of the legal matter.

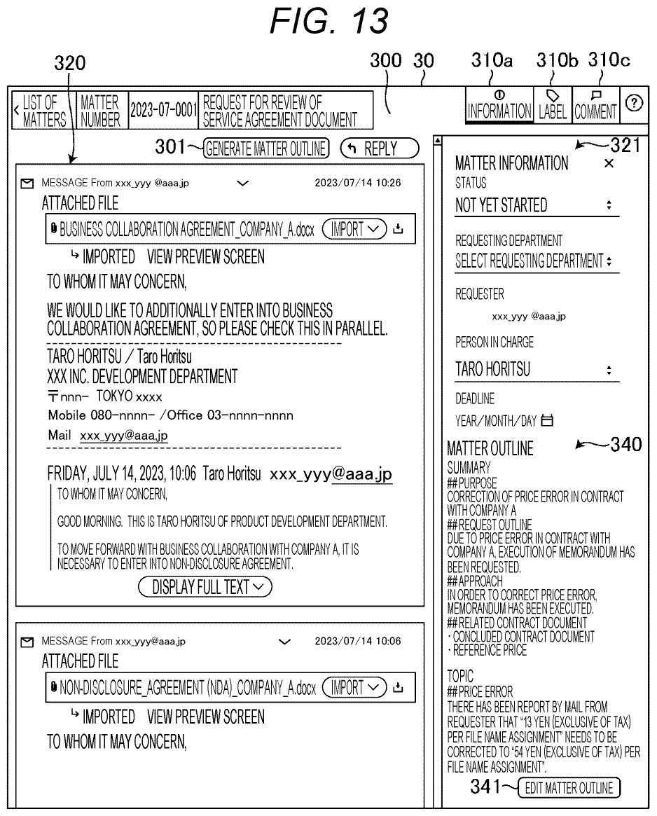

FIG. 13 is a diagram illustrating an example of a display mode of a matter outline of a legal matter according to the present embodiment. In the example of FIG. 13, when the “information” tab 310a is selected by the user P1, a matter outline display area 340 may be provided in the tab display area 321. Further, when the “information” tab 310a is selected by the user P1, the display control unit 114 may display the “summary” and the “topic” in the matter outline display area 340 in the tab display area 321 of the matter display screen 300.

The matter outline display area 340 may be provided with a matter outline edit button 341. The matter outline edit button 341 may be, for example, a button image capable of receiving an operation of the user P1 instructing to start editing of the “summary” and the “topic”. When the user P1 presses the matter outline edit button 341, the display control unit 114 may show the matter outline edit screen 330 as a pop-up, for example.

Note that, in addition to the pop-up format illustrated in FIG. 12, the matter outline edit screen 330 may be configured such that, for example, the “summary” and the “topic” can be edited in the matter outline display area 340 in the tab display area 321.

Note that the screen displays illustrated in FIGS. 11 to 13 are all examples, and screen layouts and various types of information to be displayed are not limited to the examples described above. In addition, only one of the “summary” or the “topic” of the matter outline may be displayed.

Furthermore, the screen displayed by the display control unit 114 is not limited to the above-described example. For example, the display control unit 114 may cause the display device 30 to display an input screen for the user P1 to input text data for matter outline generation of a legal matter.

Furthermore, the information processing device 10 may further include other functions. For example, the information processing device 10 may have the above-described document creation support function and document browsing function. In a case where the information processing device 10 has the document browsing function, for example, the user P1 may be able to execute document review processing from a screen of the browser, such as the matter display screen 300.

### Functional Configuration of Terminal Device T1

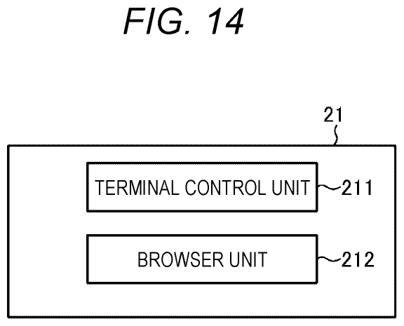

Next, a functional configuration of the terminal device T1 will be described. FIG. 14 is a diagram illustrating an example of functional blocks of the terminal device T1 according to the present embodiment. The terminal device T1 may include, for example, a terminal control unit 211 and a browser unit 212 as functions implemented by the processor 21. Each of the functions implemented by the terminal control unit 211 and the browser unit 212 may be stored as a program in, for example, the main storage device 23, the auxiliary storage device 25, or the like. The processor 21 can implement various functions (the terminal control unit 211 and the browser unit 212) by reading and executing the program stored in the main storage device 23, the auxiliary storage device 25, or the like.

For example, the terminal control unit 211 may activate the browser unit 212 in response to an instruction from the user P1.

The browser unit 212 may be, for example, a general web browser, and can execute processing according to HTML data, script, or the like. When being activated, the browser unit 212 can transmit an initial access URL to the information processing device 10 to make access.

The browser unit 212 of the present embodiment can display data including text data and image data received from the information processing device 10 on the display device 30 of the terminal device T1 in a predetermined form. In other words, the browser unit 212 can cause the display device 30 to display a screen generated by the display control unit 114 of the information processing device 10. For example, the browser unit 212 may cause the display device 30 to display the matter display screen 300 and the matter outline edit screen 330 illustrated in FIGS. 11 to 13, on the basis of data and layout information received from the information processing device 10. In addition, the browser unit 212 may cause the display device 30 to display a text data input screen for matter outline generation of a legal matter.

In addition, the browser unit 212 may transmit an operation performed by the user P1 on the screen displayed on the display device 30, to the information processing device 10 via the network N. For example, when the user P1 operates the input device 31 to press the tabs 310a to 310c, the matter outline generation button 301, or the matter outline edit button 341, the browser unit 212 may transmit information indicating the pressing of the button to the information processing device 10. Further, when the user P1 operates the input device 31 to edit the “summary” or the “topic” on the matter outline edit screen 330 and then presses the registration button 333, the browser unit 212 may transmit the “summary” and the “topic” displayed on the matter outline edit screen 330 to the information processing device 10.

When the user P1 inputs text data for matter outline generation of a legal matter on the input screen displayed on the display device 30, the browser unit 212 may transmit the input text data to the information processing device 10.

### Matter Outline Generation Processing for Legal Matter

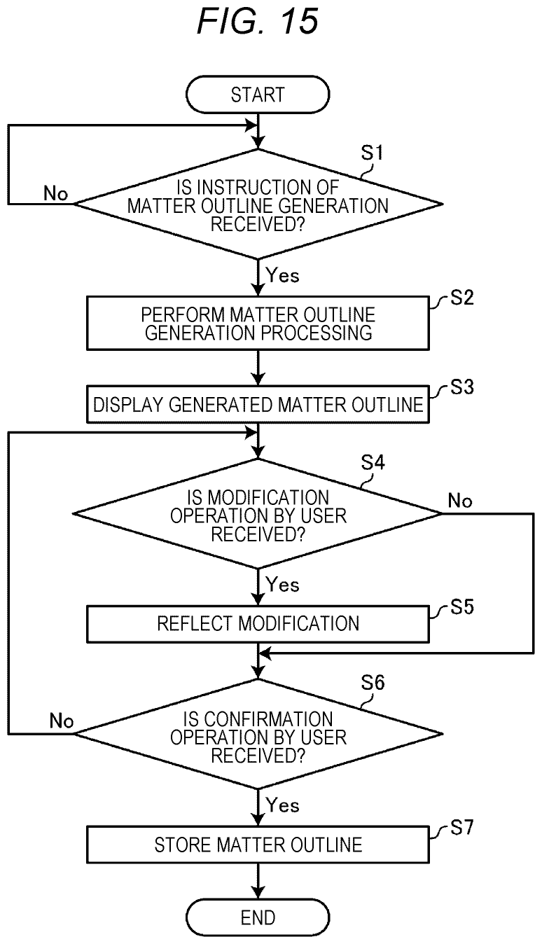

Next, a flow of matter outline generation processing for a legal matter in the present embodiment will be described. FIG. 15 is a flowchart illustrating an example of a flow of the matter outline generation processing for a legal matter according to the present embodiment. As a premise of the processing of this flowchart, the terminal control unit 211 of the terminal device T1 may have activated the browser unit 212 in response to an instruction from the user P1, for example. In addition, it may be assumed that the matter display screen 300 is displayed on the display device 30, by the display control unit 114 of the information processing device 10 and the browser unit 212 of the terminal device T1.

First, when an instruction of matter outline generation has been received from the user P1 (S1 “Yes”), the matter outline generation unit 113 of the information processing device 10 may execute the matter outline generation processing (S2).

More specifically, when the user P1 presses the matter outline generation button 301 displayed on the matter display screen 300, the browser unit 212 of the terminal device T1 may notify the information processing device 10 that the matter outline generation button 301 has been pressed. Then, the matter outline generation unit 113 may input, to the trained model, text data regarding a legal matter that is a target of matter outline generation, a prompt for “summary” generation, and a prompt for “topic” generation, thereby causing the trained model to output a “summary” and a “topic”. Note that the text data to be input to the trained model may be acquired in advance by the acquisition unit 111 and stored in the auxiliary storage device 15 or the like, or may be input by the user P1 together with an instruction of matter outline generation from the user P1.

Until an instruction of matter outline generation is received, the display control unit 114 may continue the display of the matter display screen 300 and wait in a state in which an instruction of matter outline generation can be received (S1 “No”).

Then, the display control unit 114 may display the matter outline generated by the trained model on the matter outline edit screen 330 (S3). More specifically, the display control unit 114 of the information processing device 10 may transmit, to the terminal device T1, layout information of the matter outline edit screen 330 and text data of the matter outline generated by the trained model. Further, the browser unit 212 of the terminal device T1 may cause the display device 30 to display the matter outline edit screen 330 including the “summary” and the “topic”, on the basis of the layout information transmitted from the information processing device 10 and the text data of the matter outline generated by the trained model.

Here, when the browser unit 212 of the terminal device T1 receives a modification operation of the “summary” or the “topic” by the user P1 (S4 “Yes”), the browser unit 212 of the terminal device T1 may change the “summary” or the “topic” on the matter outline edit screen 330 reflecting the modification (S5).

Then, when the browser unit 212 of the terminal device T1 receives a confirmation operation by the user P1, for example, an operation of pressing the registration button 333 (S6 “Yes”), the browser unit 212 of the terminal device T1 may transmit the “summary” and the “topic” displayed on the matter outline edit screen 330 to the information processing device 10. In this case, the registration processing unit 115 of the information processing device 10 may store the edited “summary” and “topic” in the auxiliary storage device 15 of the information processing device 10, for example (S7).

In a case where the confirmation operation by the user P1 is not executed (S6 “No”), the display control unit 114 of the information processing device 10 and the browser unit 212 of the terminal device T1 continue to display the matter outline edit screen 330 in a state in which editing by the user P1 may be possible. In addition, since it may not be essential for the user P1 to modify the “summary” and the “topic”, the confirmation operation by the user P1 may be executed without receiving the modification operation by the user P1 (S4 “No”).

When the “summary” and the “topic” are stored on the basis of the confirmation operation by the user P1, the processing of this flowchart may end.

As described above, the information processing device 10 according to the present embodiment can input text data related to a legal matter to the trained model, and can output a matter outline that is generated by the trained model on the basis of the text data and is related to at least a past background of the legal matter and an item regarding examination of a legal document related to the legal matter. Therefore, according to the information processing device 10 of the present embodiment, it may be possible to support the user P1 who is a person in charge or another user to be involved in the legal matter later to easily grasp the matter outline including the past background of the legal matter. That is, according to the information processing method executed by the information processing device 10 of the present embodiment, it may be possible to provide a support technology capable of improving efficiency of use of information regarding legal affairs.

In addition, the information processing device 10 according to the present embodiment may output the “summary” and the “topic” separately from each other in the matter outline. Therefore, according to the information processing device 10 of the present embodiment, the user P1 and another user can quickly grasp a flow of the past background of the legal matter and an item regarding examination of the legal document.

In addition, the information processing device 10 according to the present embodiment can display the matter outline generation button 301 capable of receiving an instruction of matter outline generation from the user P1. When the matter outline generation button 301 receives the instruction of matter outline generation from the user P1, the information processing device 10 can input text data related to the target legal matter to the trained model, and can output at least sentences of the “summary” and the “topic”. Therefore, according to the information processing device 10 of the present embodiment, the user P1 can confirm the matter outline of the legal matter at a desired timing. The timing at which the user P1 issues the instruction of matter outline generation may be, for example, when the legal matter is completed or when a response on the user P1 side is completed and the user P1 is in a state of waiting for a response from the other party side for the legal matter. However, without limiting to these examples, the user P1 may perform the operation of generating the matter outline at any timing.

In addition, the information processing device 10 according to the present embodiment can display information related to a legal matter separately in the plurality of tabs 310a to 310c, and can display a matter outline related to the legal matter in any one of the plurality of tabs. Therefore, according to the information processing device 10 of the present embodiment, the user P1 can easily operate display and non-display of the matter outline by selecting the tabs 310a to 310c as a display target.

In addition, the information processing device 10 according to the present embodiment can input, to the trained model, text data related to a legal matter as a matter outline generation target and a prompt for “summary” generation. The prompt for “summary” generation in the present embodiment may include a plurality of categories included in a background and at least one example for each of the plurality of categories. In response to the prompt, the information processing device 10 of the present embodiment can output a sentence that is generated by the trained model and is related to the background of the legal matter including the plurality of categories. Therefore, according to the information processing device 10 of the present embodiment, it may be possible to provide the user P1 with the past background of the legal matter in a format organized by category.

Furthermore, the information processing device 10 according to the present embodiment may input text data related to a legal matter and a prompt for “topic” generation to the trained model. The prompt for “topic” generation may include at least a first step of extracting a topic that has been discussed from the text data, and a second step of extracting an item regarding modification of the legal document from an extraction result of the first step. Therefore, according to the information processing device 10 of the present embodiment, it may be possible to accurately extract an item regarding modification of the legal document from the input text data.

### Second Embodiment

In the first embodiment described above, the information processing device 10 can generate a matter outline of a legal matter with an instruction of the user P as a trigger. However, in this second embodiment, an information processing device 10 can automatically generate a matter outline regardless of an instruction of the user.

A configuration of an information processing system S may be similar to that of the first embodiment described with reference to FIG. 1. Furthermore, hardware configurations and functional configurations of the information processing device 10 and a terminal device T1 may be similar to those of the first embodiment described with reference to FIGS. 2 to 4.

In addition to functions similar to those of the first embodiment, a matter outline generation unit 113 of the present embodiment can have a function of generating a matter outline at a time of generating a legal matter. The time of generating a legal matter may be, for example, when a legal matter is registered in an information processing device 10 and a matter number is issued.

In addition, the matter outline generation unit 113 of the present embodiment can generate a matter outline of a legal matter every time the legal matter progresses. The matter outline generation unit 113 overwrites a past matter outline each time a new matter outline may be generated. The case where the legal matter has progressed may be, for example, a case where information related to the legal matter has been updated. The case where information related to the legal matter is updated may include a case where new information is registered and a case where existing information is changed. Specific examples of registration of new information related to a legal matter may include addition of text data or a file, such as update of a timeline related to the legal matter or transmission and reception of e-mails. The update of a timeline or transmission and reception of e-mails may be also referred to as update of communication related to a legal matter. Specific examples of the case where existing information is changed may include, for example, a change in a status, a requesting department, a requester, a person in charge, a deadline, and the like of a legal matter included in matter information. Note that a past matter outline may be stored and browsed as an old version of the matter outline without being overwritten.

The matter outline automatically generated by the matter outline generation unit 113 of the present embodiment can be modified by a user P1. When the user P1 modifies the automatically generated matter outline, the matter outline generation unit 113 may stop automatic update of the matter outline of the legal matter. In this case, the matter outline generation unit 113 may be set so as not to change or overwrite the matter outline of the legal matter without an instruction by the user P1. In this case, even if communication related to the legal matter is newly updated, the matter outline generation unit 113 may not automatically overwrite and update the matter outline modified by the user P1. As a technique of stopping the automatic update of the matter outline, for example, a flag defining on/off of the automatic update may be provided in an auxiliary storage device 15. In the information processing device 10 of the present embodiment, by stopping the automatic update of the matter outline modified by the user P1, it may be possible to avoid deletion or replacement of a sentence of the matter outline edited by the user P1 due to the automatic update. Note that setting not to change or overwrite the matter outline of the legal matter may be performed by the system. For example, in a case where information of threaded e-mails is automatically imported and used as text data, in the same threaded e-mails, a topic (for example, a new legal matter or the like that is different in terms of a discussion) that is less relevant to the legal matter may be started. In such a case, if a matter outline is automatically generated, changed, or overwritten by using information that is less relevant to the previous legal matter, the matter outline may not be an appropriate summary of the legal matter. Therefore, when it is determined that a change of the matter outline is unnecessary on the basis of an analysis result of a difference in the added text data and information and other information such as a status of the matter, the matter outline can be set not to be changed or overwritten.

In addition, similarly to the first embodiment, the matter outline generation unit 113 of the present embodiment can also generate a matter outline when receiving an instruction of matter outline generation from the user P. Note that, even in a case where modification is performed by the user P at a time of initial generation of the matter outline, when the instruction of matter outline generation from the user P is received, the matter outline generation unit 113 can also generate a new matter outline and overwrite the matter outline generated in the past. For example, when the user P presses a matter outline generation button 301, the matter outline generation unit 113 may newly generate a matter outline and overwrites the matter outline generated in the past.

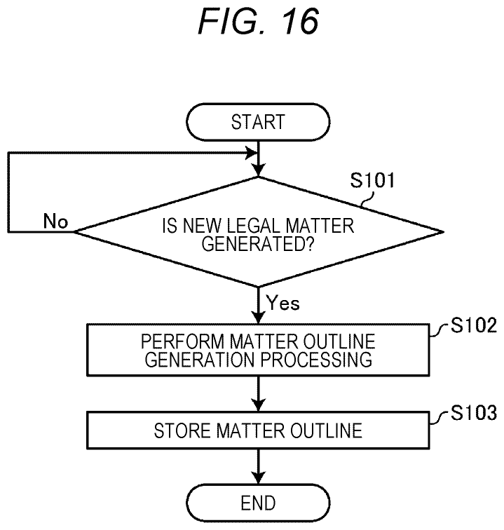

FIG. 16 is a flowchart illustrating an example of a flow of matter outline automatic generation processing for a legal matter according to the present embodiment.

When a new legal matter is generated (S101 “Yes”), the matter outline generation unit 113 of the information processing device 10 may execute the matter outline generation processing (S102). In addition, in a case where no legal matter has been generated (S101 “No”), the matter outline generation processing may not be triggered, and the processing may not be started.

Then, the registration processing unit 115 may store a matter outline including a “summary” and a “topic” generated by the matter outline generation unit 113, into the auxiliary storage device 15 of the information processing device 10, for example (S103). The stored matter outline may be displayed on a matter display screen 300 by the display control unit 114, for example, when the user P opens the matter display screen 300 next time. Here, the processing of this flowchart ends.

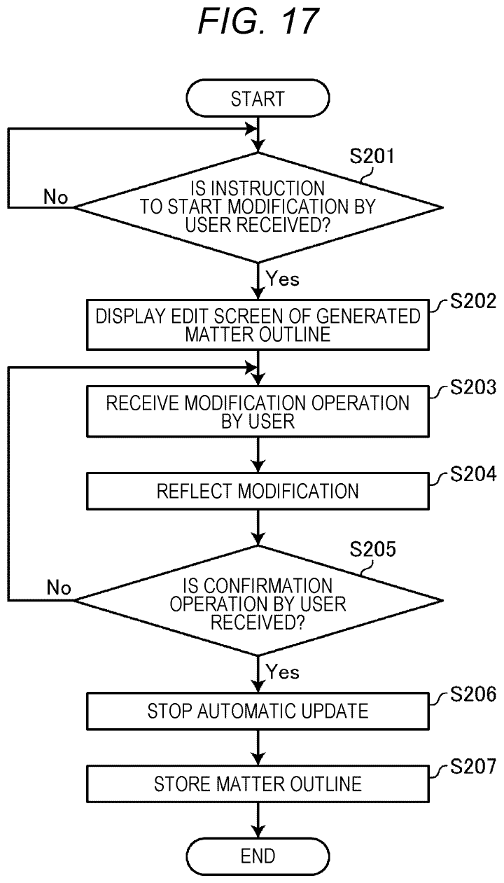

In addition, the matter outline automatically generated by the processing of FIG. 16 described above can be modified by the user P. FIG. 17 is a flowchart illustrating an example of a flow of matter outline modification processing for a legal matter according to the present embodiment.

For example, in addition to a configuration similar to that of the first embodiment, the matter display screen 300 of the present embodiment may further include a matter outline edit button, which is a button image capable of receiving an instruction to start modification of a matter outline by the user P1. Note that the matter outline generation button 301 may also function as a matter outline edit button. In a case where pressing of the matter outline edit button by the user P1 has been received, that is, an instruction to start modification of the matter outline by the user P1 has been received (S201“Yes”), the display control unit 114 of the present embodiment may display the generated matter outline in an editable state on the matter outline edit screen 330 (S202).

In a case where an instruction to start modification of the matter outline by the user P1 by the user P1 has not been received (S201 “No”), the display control unit 114 continues to display the matter display screen 300 and waits in a state in which an instruction to start modification of the matter outline can be received.

Then, the browser unit 212 of the terminal device T1 may receive a modification operation of the matter outline by the user P1 (S203), and change the matter outline on the matter outline edit screen 330 reflecting the modification (S204).

Then, when the browser unit 212 of the terminal device T1 receives a confirmation operation by the user P1, for example, an operation of pressing a registration button 333 (S205 “Yes”), the browser unit 212 of the terminal device T1 may transmit the “summary” and the “topic” displayed on the matter outline edit screen 330 to the information processing device 10. In this case, the matter outline generation unit 113 of the information processing device 10 may stop automatic update of the matter outline of the legal matter modified by the user P1 (S206). Thereafter, in this case, the matter outline generation unit 113 may not change or overwrite the matter outline of the legal matter without an instruction by the user P.

The registration processing unit 115 of the information processing device 10 may store the modified matter outline in the auxiliary storage device 15 of the information processing device 10, for example (S207).

Note that, in a case where a confirmation operation by the user P1 has not been received (S205 “No”), the display control unit 114 may continue the display of the matter outline edit screen 330 and continue a state in which a modification operation by the user P1 can be received. Here, the processing of this flowchart may end.

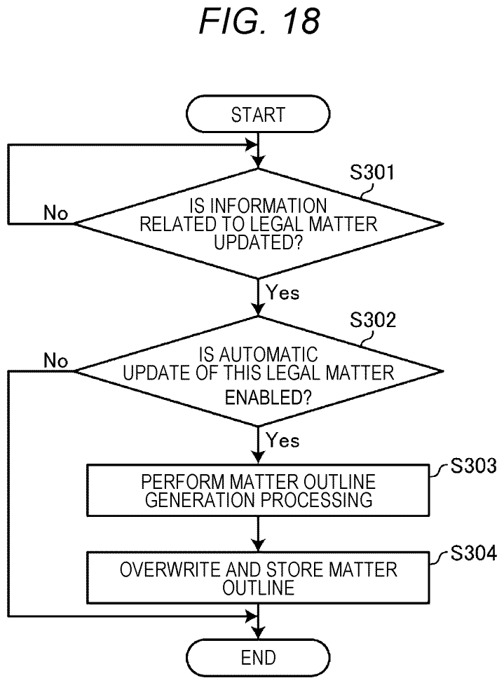

Further, in addition to the manual update by the user P1, automatic update of the matter outline may be executed by the information processing device 10. FIG. 18 is a flowchart illustrating an example of a flow of matter outline automatic update processing for a legal matter according to the present embodiment.

In a case where information related to a legal matter has been updated (S301 “Yes”) and automatic update of the legal matter is enabled (S302 “Yes”), the matter outline generation unit 113 of the information processing device 10 can execute the matter outline generation processing (S303). At this time, the matter outline generation unit 113 can generate a matter outline by inputting the latest text data to the trained model at a time of execution of the matter outline generation processing. That is, the matter outline generation unit 113 can generate a new matter outline in consideration of the information updated in S301.

Then, the registration processing unit 115 may overwrite, for example, an existing matter outline stored in the auxiliary storage device 15 of the information processing device 10 with the matter outline including a “summary” and a “topic” generated by the matter outline generation unit 113 (S304).

In a case where information related to a legal matter has not been updated (S301 “No”), the matter outline generation processing may not be triggered, and the processing may not be started. Further, even when information related to a legal matter has been updated, if automatic update of the legal matter is disabled or stopped (S302 “No”), the matter outline generation processing is not executed, and the processing of this flowchart ends.

As described above, the information processing device 10 according to the present embodiment can generate a matter outline related to a legal matter when the legal matter is newly generated, and can overwrite and update the generated matter outline when information related to the legal matter is updated. Therefore, according to the information processing device 10 of the present embodiment, when a new legal matter is generated or when the legal matter has progressed, the matter outline can be generated without requiring an instruction from the user P1. Therefore, it may be possible to reduce time and effort of the user P1 performing work of generating or updating a matter outline every time a legal matter is generated or progresses. Further, according to the information processing device 10 of the present embodiment, since a matter outline is automatically updated when a new legal matter is generated or when the legal matter progresses, it may be possible to reduce a discrepancy between a latest status of the legal matter and the matter outline displayed on the screen.

Note that, in the present embodiment, the matter outline generation unit 113 can execute automatic update of a matter outline in both a case where a legal matter is newly generated and a case where information related to the legal matter is updated, but the automatic update may be executed only in one of the cases. That is, the matter outline generation unit 113 may generate a matter outline related to a legal matter in at least one of a case where a legal matter is newly generated or a case where information related to the legal matter is updated.

### Modification 1

In each of the above-described embodiments, the display control unit 114 can display a matter outline including a “summary” and a “topic” in the matter outline display area 340 in the tab display area 321, but the display mode of the matter outline is not limited thereto.

For example, the display control unit 114 of the present modification can always display the matter outline in a header portion at a top of the matter display screen 300.

With such display, in the information processing device 10 of the present modification, when the user P1 opens the matter display screen 300, it may be possible to immediately confirm the matter outline including the “summary” and the “topic”.

Alternatively, the display control unit 114 may provide a button image enabling switching between display and non-display of the matter outline on the matter display screen 300, and may switch between display and non-display of the matter outline when the button image is pressed by the user P1.

### Modification 2

In the first embodiment described above, a “summary” and a “topic” of a matter outline are generated with an instruction of the user P1 as a trigger. Further, in the second embodiment described above, a matter outline may be generated when a legal matter is created. However, the trigger for generating the matter outline is not limited thereto.

For example, the matter outline generation unit 113 of the information processing device 10 may automatically generate a matter outline when a state corresponds to at least one of: a case where the legal matter is completed; a case where the user P1 waits for a response from the other party for a legal matter; a case where information regarding a legal matter has not been updated for a prescribed period; or a case where a legal matter is associated with another legal matter. The prescribed period may be, for example, one week. Furthermore, the user P1 or an administrator of the information processing device 10 may be able to set the prescribed period. The completion of the legal matter may mean that, for example, a status field of matter information in the tab display area 321 is changed to “completed” by the user. Examples of the case where a legal matter is associated with another legal matter may include, for example, a case where it is estimated that another legal matter is similar to the legal matter and thus is preferably referred to by the user, and a case where it is estimated that legal matters affect each other such as a legal matter at a time of execution of a master agreement and a legal matter at a time of execution of an individual agreement based on the master agreement.

Furthermore, a matter outline may be generated when a user different from the user in charge of a matter accesses the matter. As a result, an outline of a legal matter can be generated at an efficient timing. This may be preferable because cost can be reduced particularly in a case where a trained model for generating a matter outline is present outside the information processing system S, a user is different from the user P and an operator of the information processing system S, and a pricing model is usage-based pricing associated with generation. In addition, regarding the operation of generating the matter outline, the operation of generating the matter outline may be performed by a user different from the user in charge of the matter. The generation instruction can be issued at any timing, and can be issued, for example, when it is desired to refer to handling of the legal matter as a past similar matter.

For example, in a case where the matter outline generation unit 113 automatically generates a “summary” and a “topic”, the display control unit 114 can display the matter outline including the “summary” and the “topic” when the user P1 opens the matter display screen 300 next.

In addition, the matter outline generation unit 113 of the information processing device 10 may execute the matter outline generation processing in response to a plurality of triggers. For example, in any of: a case where the legal matter is completed; a case where the user is in a state of waiting for a response from the other party for the legal matter; and a case where information regarding the legal matter has not been updated for a prescribed period, the matter outline generation unit 113 may generate a matter outline of the legal matter.

### Modification 3

In the above-described embodiments, the trained model is stored outside the information processing device 10, but the trained model may be stored in the auxiliary storage device 15 of the information processing device 10, for example. Furthermore, the trained model may be incorporated in the matter outline generation unit 113 of the information processing device 10.

Furthermore, the trained model may be different for each of companies to which the users P1 to PN belong. For example, the trained model may be a model trained using different training data in accordance with needs of each company. Alternatively, fine tuning may be performed according to needs of the user or each group to which the user belongs. In addition, for a similar purpose, it is also possible to provide another trained model that appropriately processes data before input of information to a common external trained model or after output of information from the common external trained model. In addition, while using a general-purpose trained model, additional learning, fine tuning, and another trained model may be provided to enable appropriate interpretation of legal matters based on information regarding legal practice, laws, and the like, or to obtain appropriate output for summarizing the matter.

Furthermore, in the above-described embodiments, while the user P1 can modify the “summary” and the “topic” output from the trained model, the trained model may be trained on a modification result by the user P1 to improve accuracy of matter outline generation.

### Modification 4

In the above-described embodiments, the matter outline generation unit 113 generates a “summary” and a “topic” from text data using the trained model, but the “summary” and the “topic” may be generated by further referring to information other than the text data. For example, the matter outline generation unit 113 may extract “related contract document” included in the “summary” and a topic that is included in the “topic” and in which modification is applied to a legal document, on the basis of an update log or the like of a legal document related to a legal matter that is a target of matter outline generation. The extraction may be performed by the trained model or may be performed by another search function or the like.

Although the embodiments of the present disclosure have been described in detail above, these embodiments have been presented as examples, and are not intended to be limited to individual embodiments. The embodiments can be modified by various additions, changes, replacements, partial deletions, combinations, and the like without departing from the technical idea of the present invention. These embodiments and modifications thereof are included in the invention described in the claims and an equivalent scope thereof.

1. An information processing method comprising:
inputting text data related to a legal matter into a trained model; and
outputting a matter outline that is generated by the trained model on the basis of the text data and is related to at least a past background of the legal matter and an item regarding examination of a legal document related to the legal matter.

2. The information processing method according to claim 1, wherein
the matter outline includes a first sentence related to the past background of the legal matter and a second sentence related to an item regarding examination of the legal document,
the information processing method further comprises outputting the first sentence and the second sentence separately.

3. The information processing method according to claim 1, further comprising:
generating the matter outline related to the legal matter when the legal matter is newly generated; and
overwriting and updating the generated matter outline when information related to the legal matter is updated.

4. The information processing method according to claim 1, further comprising:
displaying a reception unit capable of receiving an instruction of matter outline generation from a user;
inputting the text data to the trained model when the reception unit receives the instruction of the matter outline generation from the user, and
outputting the matter outline generated by the trained model.

5. The information processing method according to claim 1, further comprising:
inputting the text data related to the legal matter to the trained model; and
outputting the matter outline generated by the trained model,
when the legal matter is in at least one of the following states: a state in which the legal matter is completed; a state in which a user is waiting for a response from the other party regarding the legal matter; or a state in which information regarding the legal matter has not been updated for a prescribed period.

6. The information processing method according to claim 1, further comprising:
displaying information related to the legal matter separately in a plurality of screen areas;
displaying the matter outline related to the legal matter in any one of the plurality of screen areas; and
displaying the legal document in any one of the plurality of screen areas.

7. The information processing method according to claim 1, further comprising:
displaying a screen on which information regarding the legal matter is displayed; and
displaying the matter outline related to the legal matter at a top of the screen.

8. The information processing method according to claim 1, further comprising:
inputting a first prompt and the text data related to the legal matter into the trained model; and
outputting a sentence generated by the trained model and related to the past background of the legal matter including a plurality of categories, wherein
the first prompt includes the plurality of categories included in the past background and at least one example for each of the plurality of categories.

9. The information processing method according claim 1, further comprising:
inputting a second prompt and the text data related to the legal matter into the trained model, wherein
the second prompt includes at least a first step of extracting a topic that has been discussed from the text data, and a second step of extracting an item regarding modification of the legal document from an extraction result of the first step.

10. An information processing device comprising:
at least one processor, wherein
the at least one processor
inputs text data related to a legal matter into a trained model, and
outputs a matter outline that is generated by the trained model on the basis of the text data and is related to at least a past background of the legal matter and an item regarding examination of a legal document related to the legal matter.
